(19) United States
(12) Patent Application Publication
(10) Pub. No.: US 2011/0170788 A1
(43) Pub. Date: Jul. 14, 2011

(54) METHOD FOR CAPTURING DATA FROM MOBILE AND SCANNED IMAGES OF BUSINESS CARDS

(76) Inventor: GRIGORI NEPOMNIACHTCHI, San Diego, CA (US)

(21) Appl. No.: 12/686,290

(22) Filed: Jan. 12, 2010

(51) Int. Cl. G06K 9/72; G06F 17/27

(52) U.S. Cl. 382/229; 704/9

(57) ABSTRACT

According to various embodiments of the invention, methods are provided for capturing various data fields from mobile and scanned images of business cards. Most embodiments are provided for capturing Personal and Company name fields, which are difficult to identify using conventional OCR and data capture techniques. In addition, some embodiments of the invention involve methods for capturing an email, URL or telephone number from an image of a business card.

### TECHNICAL FIELD

The present invention relates generally to capturing data from images, and more particularly, some embodiments relate to methods for capturing data from mobile and scanned images of business cards.

### DESCRIPTION OF THE RELATED ART

Optical character recognition (OCR) is the mechanical or electronic translation of images of handwritten, typewritten or printed text (usually captured by a scanner) into machine-editable text. It is used to convert books and other documents into electronic files, for instance, to computerize an old record-keeping method in an office, or to serve on a website.

When one scans a paper page into a computer, it produces just an image file, i.e., a photo of the page. Since the computer cannot understand the letters on the page, one cannot search for words or edit it and have the words re-wrap as you type, or change the font, as in a word processor. OCR methods are used to convert it into a text or word processor file so that one can search for words, etc. The result is much more flexible and compact than the original page photo.

Conventional OCR methods, however, are not used for capturing data from mobile and scanned images of business cards.

### BRIEF SUMMARY OF EMBODIMENTS OF THE INVENTION

The present invention is directed toward methods for capturing data from mobile and scanned images of business cards. One embodiment of the invention involves a method for capturing data from a business card containing multiple fields, comprising: generating a list of text line-based name alternatives (referred to herein as “T-alternatives”) for each field; computing an ASCII value for each T-alternative; and computing a confidence for each T-alternative. The list of T-alternatives may be ordered from highest to lowest confidence. The step of generating a list of T-alternatives for each field may entail determining a list of T-alternatives for a PersonalName field and a list of T-alternatives for a CompanyName field.

In some embodiments, the confidence for each T-alternative is computed as a weighted average, wherein computing the confidence for a T-alternative comprises the steps of: inputting a T-alternative; computing one or more features of the T-alternative; computing a value for each feature; inputting an array of weights, one per feature; and computing a weighted average for the T-alternative. The computed features may comprise text segmentation features, location features, content features, font features, and/or features for matching against email and URL fields. The weighted average may be computed using the formula:

V=Σ(F[i]*W[i])/ΣW[i], where

F[i] is the value of the i-th feature,

W[i] is the weight of the i-th feature, and

Σ is the summation over all features.

Another embodiment of the invention involves a method for capturing an email, URL or telephone number from an image of a business card having multiple fields, comprising: selecting a particular field; inputting a set of keywords for the field; inputting OCR results of the image including ASCII and location information; inputting a format of the field; determining any alternative keyword locations within the OCR results along with corresponding match confidences; determining any alternative data locations within the OCR results along with corresponding match confidences; and combining the keyword locations and data locations such that the keywords are properly aligned with the data, with no other text items in between. The method may further comprise sorting all found field alternatives from higher to lower confidences. The step of inputting a format of the field may be performed using a regular expression mechanism, wherein the various format-related factors are converted into rules that are used to identify alternative locations within the input text that may be data positions or keyword positions.

A further embodiment of the invention involves a method for determining a confidence of a match against a name part of an email address captured from a business card, the method comprising: inputting a T-alternative of the name part of the email address; determining whether a middle initial is present in the T-alternative and removing the middle initial if present; determining whether a first name is present and creating a second T-alternative of the first name if present; inputting the email address and extracting the name part from the email address; and matching each T-alternative against the name part from the email address and determining a match confidence for each T-alternative. The method may further comprise selecting the. T-alternative having the highest match confidence.

In some embodiments, this method further comprises determining a job title corresponding to the T-alternative having the highest match confidence. This may entail the steps of: determining the job title comprises detecting text below the T-alternative using page segmentation; assigning positions, ASCII and confidences to all text locations; and selecting the job title having the highest confidence.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 illustrates an example mobile image of a business card.

FIG. 2 illustrates a page segmentation chart showing a hierarchical representation of text items in an image.

FIG. 3 depicts a flowchart of a method for the computation of T-alternative's weighted feature average as a confidence, in accordance with the principles of the invention.

FIG. 4 illustrates an example of out-of-focus mobile image of a business card.

FIGS. 5a and 5b depict a typical mobile business card image 70 (FIG. 5a) that is transformed to a black-and-white image (FIG. 5b) using the methods of the invention.

FIG. 6 depicts a table representing the most commonly used sets of keywords and format-related factors per field of interest.

FIG. 7 is a flowchart illustrating a method for capturing email, URL and various telephone numbers.

FIG. 8 depicts how average character thickness can be defined by counting pixels to determine the stroke width of a character.

FIG. 9 is a flowchart illustrating a method for determining the confidence of a match against the name part of an email address in accordance with the principles of the invention.

FIG. 10 is a flowchart depicting a method for capturing job titles in accordance with the principles of the invention.

FIG. 11 depicts a computing module suitable for implementing the various methods of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward methods for capturing data from mobile and scanned images of business cards.

The methods of the invention are designed to capture information such as email, URL, various telephone numbers, personal name, company name, and/or job title from mobile and scanned images of business cards. As set forth herein, email, URL and various telephone numbers can be captured using a combination of certain sets of keywords (textual clues) and data formats. By way of example, job titles can be determined using the predetermined locations of personal names. Specifically, a job title is virtually always located immediately below (or to the right of) the personal name.

Unlike the fields mentioned above, personal and company names are not typically labeled by any keywords. Moreover, there are no known formats which would uniquely identify these fields and therefore help to distinguish them from other text items on business cards. In view of this limitation, several of the methods of the invention are directed toward capturing personal and company names from business cards. Throughout this document, the terms “PersonalName” and “CompanyName” may be used to refer to corresponding fields on business cards. In addition, the term “Name” may be used herein to refer to either one of these fields.

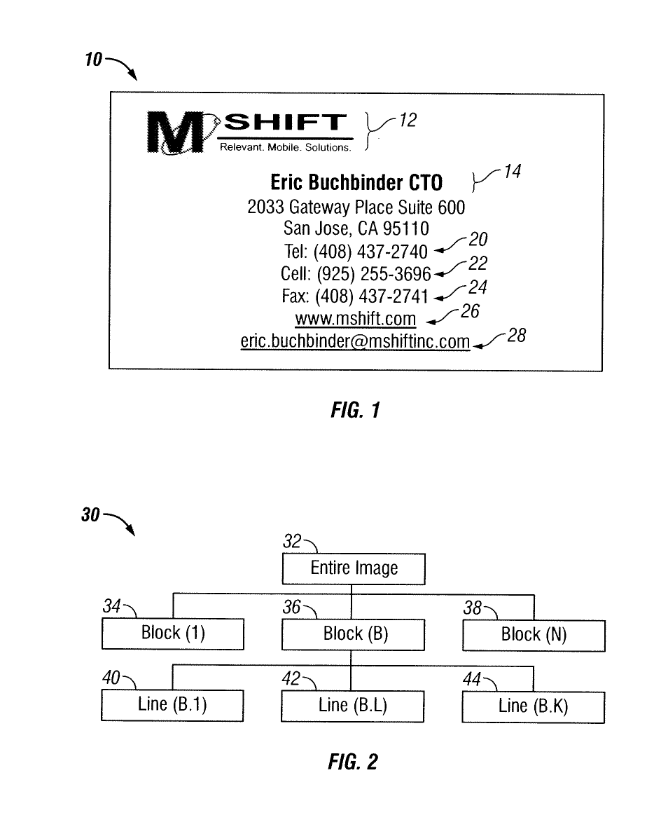

FIG. 1 depicts an example mobile image of business card 10. One can see that the various telephone numbers (in fields 20, 22, 24) are clearly identified by respective keywords (“Tel,” “Cell,” “Fax”) as well as formats. Additionally, the URL and email fields 26, 28 have uniquely defined formats. In particular, the email field contains an “@,” whereas the URL field starts with “www” and ends with “.com.” In the case of Names, it is difficult to pinpoint the exact location of PersonalName 14 (Eric Buchbinder) and CompanyName 12 (MSHIFT). However, according to embodiments of the invention, a combination of context, location, content, font and some other characteristics may be used to identify these two fields as set forth in detail hereinbelow.

Referring to FIG. 2, a page segmentation chart 30 is depicted showing a hierarchical representation of text items in an image. It is noted that OCR systems not only produce the ASCII data (representing text on the image), but also a hierarchical representation of text items in the form of page segmentation. In the illustrated figure, the entire image 32 is broken down into text blocks 34, 36, 38 (also called paragraphs), which in turn are composed of text lines 40, 42, 44, which in turn consist of words, numbers, characters, etc. The use of indices in parenthesis is provided to denote a particular block (B) and a particular text line within a particular block (B.L). The letter “N” refers to the number of text blocks (characters), while the letter “K” refers to the number of text lines in the Bth block. Additional hierarchical levels may be provided below the “Lines” level.

In accordance with some embodiments of the invention, various text line-based name alternatives will now be described. In some cases, the CompanyName is printed on business cards as a picture or an icon which cannot be properly interpreted by OCR systems. However, in a majority of cases, the CompanyName is printed on a business card in a form which can be OCR-ed. If CompanyName is indeed OCR-able, one can assume for simplicity that it occupies an entire text line. Any text line equipped with its OCR result may be referred to herein as a “T-alternative.” In addition, another type of CompanyName alternative is referred to as an “EU-alternative.” As to the PersonalName, it is always printed in OCR-able form and therefore has only T-alternatives.

Any T-alternative has a location on the business card image as well as ASCII content. As set forth below, a given T-alternative may be subjected to multiple measurements represented by various features. Each feature produces a numeric value between 0.0 and 1.0. These values are combined with corresponding field-specific weights to produce a weighted average which is used as T-alternative's “confidence” or “confidence value” representing the likelihood of it being the actual PersonalName or CompanyName.

Methods for using email and URL-fields to produce extra CompanyName alternatives will now be described. The CompanyName is very frequently (but not always) included in both the URL and email addresses found on business cards.

For this example, it is assumed that both URL and email addresses are found and correctly captured from a given business card. Given the email address, “JSmith@XYZ.com,” it is initially determined that “JSmith” comprises the name part of the email field and “XYZ” comprises the company part of the email field. In other words, all characters to the left of the ‘@’ sign constitute the “name” part, whereas those between ‘@’ and “.com” constitute the “company” part of the email. In some instances, “.com” is not employed in an email address; instead, an appropriate email ending (e.g., “.edu,” “.gov,” etc.) may be employed as an endpoint for determining the “company” part of the email.

In another example, given a URL such as “www.XYZ.com,” it is initially determined that “XYZ” comprises the “company” part of the URL. In other words, the “company” part of a URL is constituted by all characters between “www.” and “.com”. Again, in appropriate instances any widely used ending such as “.edu” and “.gov” may be employed as the endpoint instead of “.com.” The name parts of both the email and URL fields are used as additional CompanyName alternatives, which are referred to jointly as “EU-alternatives.” Since EU-alternatives do not have the context employed in the computation of all the features below, a “weighted average” cannot be computed. Instead, the respective confidences as email and URL-fields are used.

Referring again to the business card example of FIG. 1, the CompanyName is “MSHIFT.” However, due to the way “MSHIFT” is printed on the business card (in the top-left corner), it is difficult to capture for the following reasons: (i) “M” is printed in a much larger font than the rest of the CompanyName; (ii) “M” and “SHIFT” are printed in different styles; and (iii) a picture of an ellipse overlaps with “M” making it more difficult to properly OCR. As a result, the method will likely capture only the word “SHIFT” as a possible CompanyName T-alterative. Assuming that the correct email address (eric.buchbinder@mshiftinc.com) and the correct URL (“www.mshift.com”) have been properly captured, the method will add two extra CompanyName alternatives: “mshiftinc” and “mshift.” The order of these three alternatives will depend on the details of implementation and it will be up to the user to decide which one to select.

The PersonalName is also often included in the email field, but usually in an abbreviated form. A “cross-correlation” between T-alternatives and the email field may be used as one of the useful features when the confidence of a T-alternative for PersonalName is being computed. In cases that do not use the email field for producing extra PersonalName alternatives, there are only T-alternatives from which the PersonalName may be chosen.

An example T-alternative confidence value computation will now be described. Once all feature values are computed, the method uses a set of weights, one per feature, to compute the weighted average as a “confidence” of such alternatives. The PersonalName and CompanyName use the same measurements/features but two different sets of weights that have been established experimentally.

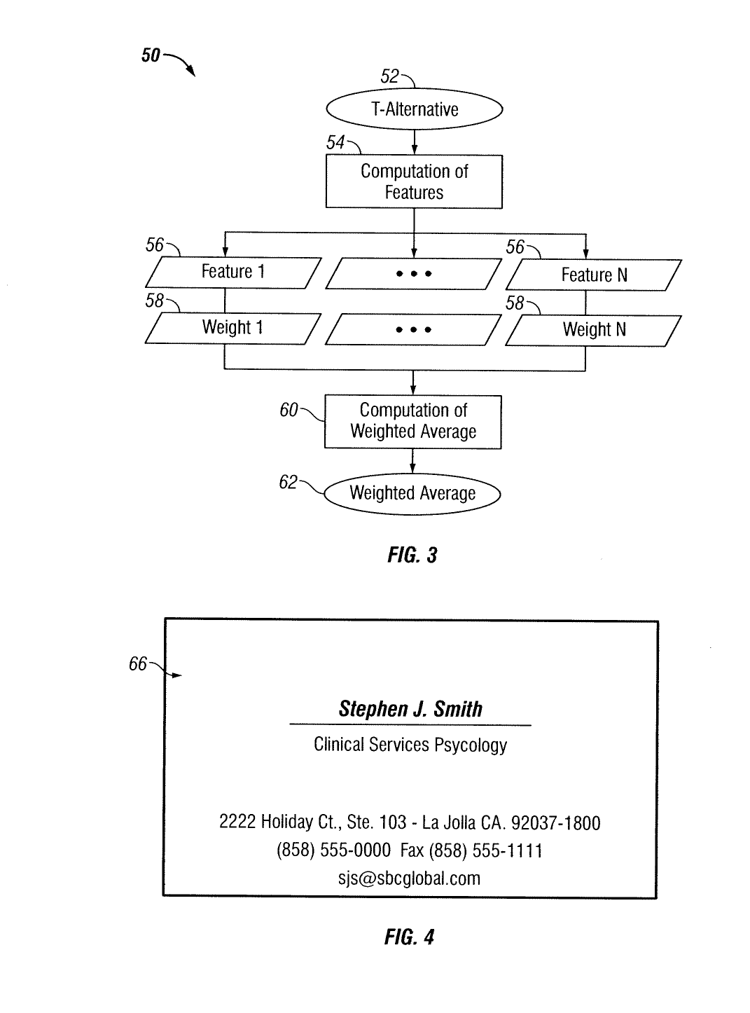

FIG. 3 depicts a flowchart 50 of a method for the computation of T-alternative's weighted feature average as a confidence value. Specifically, step 52 involves inputting a T-alternative. Step 54 involves a process of computing various features (as set forth hereinbelow). The resulting values of the features are determined in step 56. Step 58 involves inputting an array of weights, one per feature. These weights are established experimentally and are different for PersonalName and CompanyName fields. Step 60 involves the computation of a weighted average according to the following formula:

V=Σ(F[i]*W[i])/ΣW[i], where
F[i] is the value of the i-th feature,
W[i] is the weight of the i-th feature, and
Σ is the summation over all features.
   In step 62, the output value of the weighted average is used as T-alternative's confidence value.

According to the invention, a method of capturing data from business cards generates a list of alternatives per field, wherein each alternative is equipped with its ASCII value and confidence value. The list is ordered from highest to lowest confidences. Usually, such list contains more than one alternative per field from which the user may choose. In experiments using this method, the first alternative is correct in about 90-95% of cases. The list of alternatives for the PersonalName field contains only T-alternatives with confidence values computed as a weighted average as described with respect to FIG. 3.

The list of alternatives for the CompanyName field contains T-alternatives and EU-alternatives, wherein confidence values of T-alternatives are computed as a weighted average as described with respect to FIG. 3. As set forth below, (i) confidence values of EU-alternatives are computed for email and URL fields, and (ii) the lists of alternatives for Job Title and other field are also computed.

Throughout this document, a comparison of two text strings may be employed to measure how many characters should be removed, added or replaced to make the two strings identical. If the two strings are identical, the match confidence is 1.0. The notation MatchConf(S1, S2) is used to denote matching confidence between strings S1 and S2. Unless specified otherwise, MatchConf is independent of the letter-case: e.g. MatchConf(“John”, “JOHN”)=1.0. Such a technique is widely used (e.g. in spellcheckers) and is well-known.

Preprocessing of Mobile Images

The data capture methods set forth herein require the mobile image of a business card to be converted into a black-and-white image before data is captured. Most modern scanners are equipped with software that automatically crops and binaries the document images. Therefore, the methods of the invention can be directly applied to scanned images of business cards. However, this is not the case for mobile images, which are color images (24 bit/pixel JPG) that include both the document (business card) and a background. Many different factors may affect the quality of a business card's mobile image and make it difficult to capture data. Accordingly, mobile images should be preprocessed before they are handled.

The most common optical defect for an image is being out-of-focus, and such images may be difficult to process. FIG. 4 depicts an example of out-of-focus mobile image 66 of a business card. Other optical defects include, but are not limited to, unequal contrast or brightness, shadows, etc. These defects are closely related to lighting conditions used when pictures are taken. Using a light source above a document might light the document in a way that improves the image quality, while a light source to the side of the document might produce an image that is more difficult to process (e.g., due to shadows). The type of light (e.g., sun, electric bulb, fluorescent lighting, etc.) might also be a factor. If the lighting is too bright, the document might be washed out in the image. On the other hand, if the lighting is too dark, it might be difficult to read the image.

The quality of an image may also be affected by the business card's position on a surface when photographed (e.g., upside down, skewed, etc.). View angles far from perpendicular may cause significant geometrical distortion of the image referred to as “perspective distortion.” Image quality may also be affected by the type of mobile device employed. Some mobile camera phones, for example, might have cameras that save an image using a greater number of mega pixels. Other mobile cameras phones may have an auto-focus feature, automatic flash, etc. Generally, these features might improve an image when compared to mobile devices that do not include such features.

Various mobile document image processing systems and methods take all of the above factors into consideration. Such systems and methods are described in the following patent applications, each of which is incorporate herein by reference in its entirety: (i) U.S. patent application Ser. No. 12/346,047, entitled Methods for Mobile Image Capture and Processing of Checks; (ii) U.S. patent application Ser. No. 12/346,026, entitled Systems for Mobile Image Capture and Processing of Checks; (iii) U.S. patent application Ser. No. 12/346,071, entitled Methods for Mobile Image Capture and Processing of Documents; and (iv) U.S. patent application Ser. No. 12/346,091, entitled Systems for Mobile Image Capture and Processing of Documents.

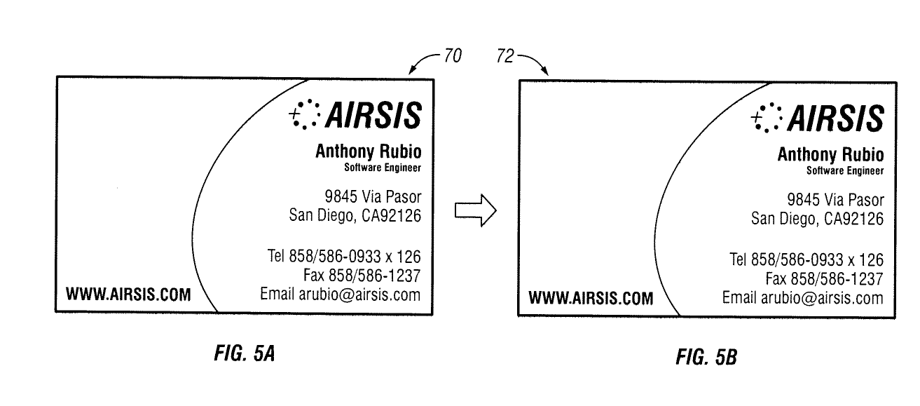

Referring to FIGS. 5a and 5b, a typical mobile business card image 70 (FIG. 5a) is transformed to a black-and-white image 72 (FIG. 5b), e.g., using the systems and methods described in the patent applications set forth in the preceding paragraph.

Capturing Email, URL and Various Telephone Numbers

As set forth above, email, URL and various telephone number fields can be captured using a combination of certain sets of keywords (textual clues) and data formats.

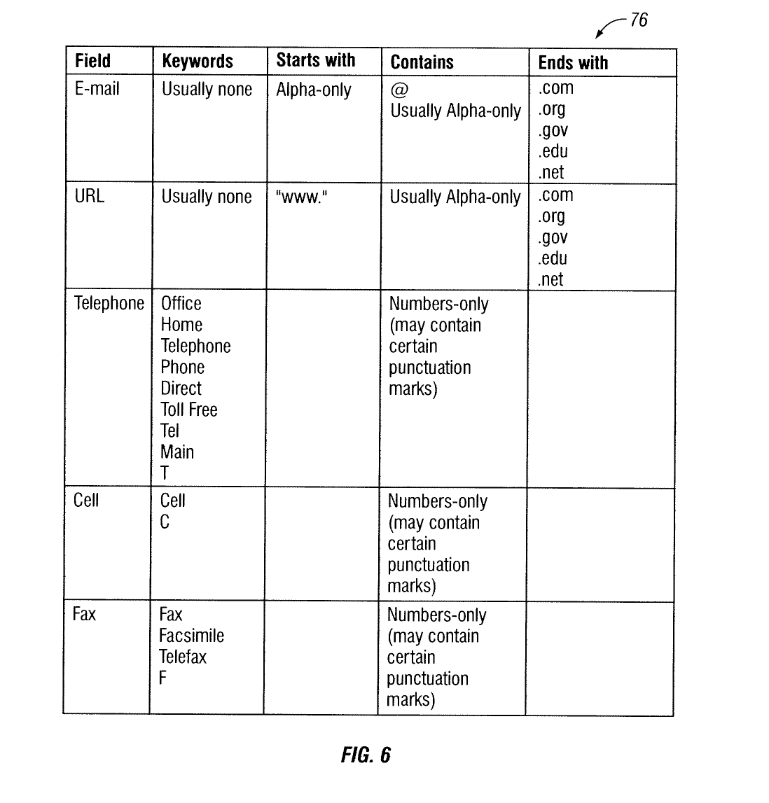

Referring to FIG. 6, the most commonly used sets of keywords and format-related factors will now be described. FIG. 6 is a table 76 representing the most commonly used sets of keywords and format-related factors per field of interest. Some embodiments of the invention employ a Regular Expression Mechanism (REM), developed by Mitek Systems, Inc., San Diego, Calif., to describe data formats. Using this mechanism, the various format-related factors are converted into rules that are used by REM to identify alternative locations within the input text, which might be positions of the field's data. The keywords can also be treated as data formats; therefore, the method under consideration may use REM to locate both the field's data and keywords within the text. As a result of this process, an alternative-to-format matching confidence is computed.

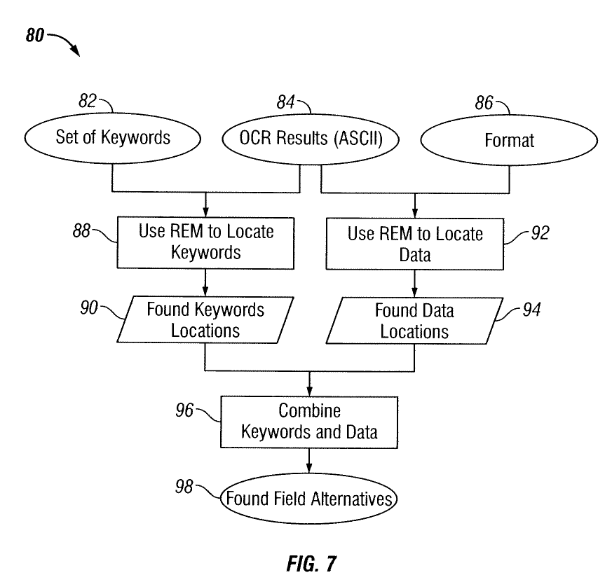

FIG. 7 is a flowchart 80 illustrating a method for capturing email, URL and various telephone numbers. In particular, assuming that a particular field of interest has been chosen, step 82 involves inputting a set of keywords for the field. In some cases, there will be no keywords in the set. Step 84 involves inputting the image's OCR results including ASCII and location information. Step 86 entails inputting the field's REM-generated format (see FIG. 6). In step 88, REM is applied to the set of keywords to find alternative locations of the keywords within the OCR results and corresponding match confidence values (against any keyword from the list). If there are no keywords, the method skips to step 92, wherein REM is used to locate data.

With further reference to FIG. 7, step 90 involves finding alternative locations for each keyword. In step 92, REM is applied to the REM-generated format to find alternative data locations within the OCR results and corresponding match confidence values (against the REM-generated format). Step 94 involves finding alternative data locations. In step 96, the keyword locations and data locations are combined such that the keywords are properly aligned with the data, with no other text items in between. In other words, the keywords and data should be immediate neighbors on the image. In step 98, all found field alternatives are sorted from higher to lower confidence values.

Features Used to Capture Names

Text segmentation features are related to the location of a particular text item within the text hierarchy (as described with respect to FIG. 2) with no regard to its content. As used herein, the term “text block” is a maximal group of adjacent text lines with relatively small vertical distances therebetween. The term “maximal” means that all other remaining text lines are located relatively far from the group (and therefore cannot be added without breaking the “small vertical distance” requirement).

As used herein, text segmentation features are abbreviated with an “S” followed by a number. Feature S1 checks if the text line is the topmost in its text block. In many cases (but not always), the Names are located at the top of corresponding text blocks. Feature S1 is Boolean in that it has a value of 1.0 when the text line is topmost in its text block; otherwise, it is 0.0. Feature S2 comprises the degree of separation. Once the text block for the alterative is established, one can also consider the “degree of separation,” which measures the vertical distance from a given text block to the nearest block above it. A useful way to measure this feature is to normalize it by the image height: if there is no text block above it, the feature value is by definition 1.0. Otherwise, S2=Dist/Height, where Dist is the distance from the given text block to the nearest block above it, and Height is the height of the image.

As used herein, location features are abbreviated with an “L” followed by a number. Location features depend on geometrical location of T-alternative only. In general, Names are rarely located at the bottom of business cards. As such, the following definition may be employed wherein Feature L1 is the top location: L1=(Height−Top)/Height, where Top is the top coordinate of the alternative (distance from the image's upper border), and Height is the height of the image. Using this formula, higher positions of T-alternative cause higher values of L1. The range of L1 is [0.0-1.0].

As used herein, content features are abbreviated with a “C” followed by a number. This group of features comprises those that depend on the content of the text line. In the following definitions, it is assumed that the recognition has been already performed and the content of the text line is known.

Feature C1 comprises the Name format compliance and reflects the fact that the PersonalName field on business cards predominantly includes the first and last name, and often include a middle initial. This assumption imposes certain restrictions on the number of words in the text line as well as on character case and punctuations. PersonalName also has very few punctuation marks (such as dots and commas) and usually does not include numbers. Before the feature is computed, the T-alternatives may potentially be represented as: <FirstName><MiddleInitial><LastName>, where <FirstName> is separated by at least one space from <MiddleInitial>, and <MiddleInitial> is separated by at least one of space/dot/comma character from <LastName> and has exactly one character.

Feature C1 is then computed as:

C1=V1+V2+V3+V4−V5−V6−V7−V8, where

V1=0.8*(NumAlpha/NumAll), where NumAlpha is the number of alphabet characters and NumAll is the total number of characters in the T-alternative. In this calculation, all punctuation marks are excluded. In addition, the ratio is multiplied by 0.8 to ensure that the final value of C1 is in the [0.0-1.0] range.

V2 is a “promotion,” which applies when first word in the line starts with a capital letter (and the second letter is lower case). V2=0.05 if promotion applies; otherwise, V2=0.

V3 is similar to V2, but applies to the last word in the text line. Again, V3=0.05 if promotion applies; otherwise, V3=0.

V4 only applies when the text could be represented as <FirstName><Middlelnitial><LastName> and <Middlelnitial> is a single upper-case letter. Again, V4=0.05 if promotion applies; otherwise, V4=0.

V5 is a “penalty” for having too many words in the alternative. If <Middlelnitial> is present, three words are expected; otherwise only two. V5 has a value of 0.03 for each extra word; otherwise, V5=0. For example, a PersonalName with two extra words has a V5 of 0.06.

V6 is a “penalty” for having too many punctuation marks in the alternative. The only un-penalized punctuation mark is the one following the <Middlelnitial>. V6 has a value of 0.02 for each extra punctuation mark; otherwise, V6=0.

V7 is a “penalty” for being too short. An alternative is considered too short if it contains less than eight characters (discounting punctuation marks). V7 has a value of 0.01 for each missing character; otherwise, V7=0.

V8 is a “penalty” for being too long. An alternative is considered too long if it contains more than 16 characters (discounting punctuation marks). V8 has a value of 0.02 for each extra character; otherwise, V8=0.

Consider the following example, wherein alternative=“Joh.n R. Smith.” This text can be represented as: <FirstName> <Middlelnitial> <LastName>, where

<FirstName>=“Joh.n” (note the extra dot)

<Middlelnitial>=“R”

<LastName>=“Smith” (note the recognition error)

After excluding punctuation marks, nine of remaining ten characters are alphabet characters. Therefore,

V1=0.8*(9/10)=0.72

V2 applies and is equal to 0.05

V3 applies and is equal to 0.05

V4 applies and is equal to 0.05

V5=0

V6=0.02 (extra punctuation in <FirstName>)

V7=0 (total number of characters discounting punctuation marks is ten)

V8=0 (same as above)

Solving the formula for Name format compliance yields a value of C1=0.85 for this example.

Feature C2 is a match against most frequently used first names. In some embodiments, this feature is based on the fact that the PersonalName on many U.S. business cards often contains one of the most common U.S. first names. In other embodiments, this feature may be based upon common first names in other countries and/or languages. In the current example, a “List” of several hundred of the most frequently used U.S. first names is employed to search within a given alternative. The name should start from the first character and be separated from the rest of the alternative's text. The length of the matched name may also be taken into account. For obvious reasons, this feature is useful for PersonalName only and its weight for Company Name is 0.0 (see FIG. 3).

Given the T-alternative's “Text” and any first name from the List (FName), the confidence of “Text” containing “FName” is computed as:

Conf(Text, FName)=IC−IP−LP, where

IC (inclusion confidence) is equal to the number of FName characters matching the corresponding Text characters, divided by FName's length

IP (isolation penalty) is a “penalty” applied when Name is not separated from the rest of Text. IP=0.2 if the penalty applies.

LP (length penalty) is a “penalty” applied when FName is too short. In some embodiments, a prohibitive penalty is applied for names shorted than four characters, a penalty of 0.40 is applied for 4-character names, and a penalty of 0.20 is applied for 5-character names. LP is zero for FNames of more than five characters.

After computing Conf (Text, FName) for each FName, a maximum of such values is used as the C2 value:

C2=max (Conf (Text, FName)), over all FNames included in the List

Consider the following example wherein:

Text=“RicnardK.Smith” (note missing space and recognition error in place of supposed ‘h’)

FName=“Richard”

IC=6/7=0.857 (since six character of the name match corresponding characters in the Text with the exception of ‘h’)

IP=0.2 (since there is no space after the first name)

LP=0.0 (Name is longer than five characters)

Conf (“RicnardK.Smith”, “Richard”)=0.657

Feature C3 comprises a match against the most frequently used name suffixes and post-nominal letters. This feature is based on the fact that the PersonalName on many business cards contains one of most frequently used suffixes or post-nominal letters (such as “MD,” “Sr,” “Jr,” “PhD,” etc.). In some embodiments, a “List” of the most frequently used U.S. name suffixes and post-nominal letters is employed to search within a given alternative. Depending on the List's entry, it should be located either at the very beginning or at the very end of the T-alternative and be separated from the rest of the text. This feature is Boolean such that the value is 1.0 when one or more of the List entries is found and 0.0 otherwise. Since such entries are short, it may be required that the match be exact such that all characters in the entry are identical (except for letter case) to the respective letters in the T-alternative. This feature is useful for PersonalName only: its weight for Company Name is 0.0 (see FIG. 3).

Feature C4 is a match against most frequently used professions based on the observation that many (but not all) PersonalNames are located directly above the profession/occupation line. In certain embodiments, a “List” of the most frequently used U.S. job titles/professions/occupations is employed to search within a text line located immediately below a given alternative.

Given the T-alternative's text line located immediately below the PersonalName (Text Below) and any job title from the List (Title), the confidence value of “TextBelow contains the Title” is computed as:

Conf(TextBelow, Title)=IC−IP−LP, where

IC (inclusion confidence) is equal to the number of Title characters matching the Text characters starting at any position within Text, divided by the Title's length.

IP (isolation penalty) is a “penalty” applied when the Title is not separated from the rest of Text. IP=0.2 if it applies.

LP (length penalty) is a “penalty” applied when the Title is too short. A prohibitive penalty is applied for job titles shorted than four characters, a penalty of 0.4 is applied for 4-character job titles, and a penalty of 0.2 is applied for 5-character job titles. LP=0.0 for job titles having more than five characters.

After computing Conf (TextBelow, Title) for each job title, a maximum of such values is used as the C4 value:

C4=max (Conf (TextBelow, Title)), over all Title's included into the List

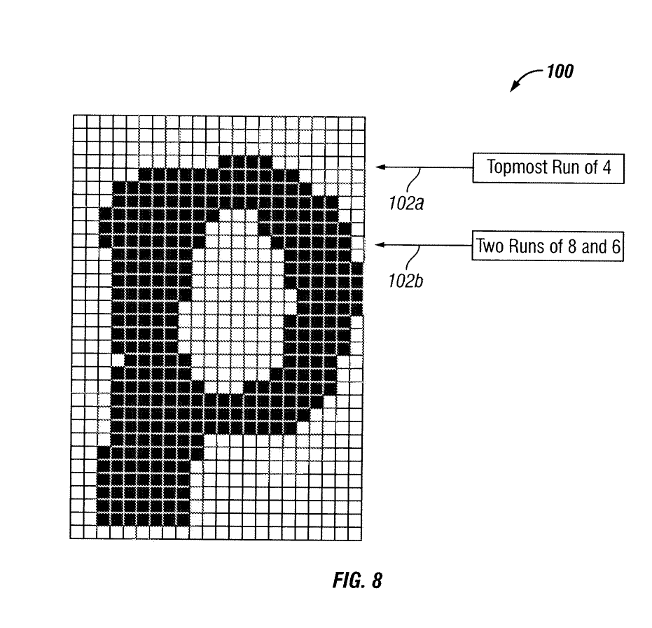

Font features depend on the printed font of a given T-alternative. As used herein, font features are abbreviated with an “F” followed by a number. The average character thickness is used as a characteristic of the font's boldness. Referring to FIG. 8, average character thickness can be defined by counting pixels to determine the stroke width of character 100. In particular, each horizontal line 102 intersects the character 100 in several solid black areas referred to as “runs.” For example, the topmost intersection 102a includes four black pixels, i.e. run length of four. At an intersection 102b, six levels below the topmost intersection 102a, the character 100 has two runs of eight and six pixels, respectively.

Given a T-alternative, a histogram is built of run lengths over all characters included in an alternative. Then, the histogram's median value is used as the alternative's boldness value. In some embodiments, a histogram is built of run lengths over all characters in the image and the histogram's median value is used as the image's average boldness value. The alternative's height value is then computed as an average of the heights of characters included in the alternative, excluding punctuation marks. The image's average height value is computed as an average of the heights of all characters in the image, again excluding punctuation marks.

Feature F1 is font boldness, which reflects the fact that Names on business cards are often printed in bolder than average font. The value of the feature is computed as follows:

F1=(AltBoldness−AveBoldness)/AveBoldness,

where AltBoldness is the alternative's boldness value and AveBoldness is the image's average boldness value defined above.

To avoid excessively large values of F1 (very bold characters may be part of company logo), the abs(F1) may be restricted by 1.0. F1 can be negative or positive.

Feature F2 comprises font height, which reflects the fact that Names on business cards are often printed in taller characters than the average. The value F2 of the feature is computed as follows:

F2=(AltHeight−AveHeight)/AveHeight,

where AltHeight is the alternative's height value and AveHeight is the image's average height value defined above.

To avoid excessively large values of F2 (very tall characters may be part of company logo), the abs(F2) may be restricted by 1.0. Similar to F1, F2 can be negative or positive.

In accordance with the principles of the invention, features for matching against email and URL fields will now be described. Features included in this group reflect certain correlation between the Names and content of URL and email fields on business cards. Such features are referred to herein as “EU-features.” In the following examples, it is assumed that both the URL and email addresses are found and correctly captured from a given business card.

Feature EU1 comprises a match against the “name” part of an email address. This feature is based on the fact that the PersonalName correlates (but is not usually identical to) the “name” part of an email field. There are several options as to how the personal name can be included in the email address. Assuming that the actual name of the person is “John S. Smith,” the following email name parts are most frequently used:

(a) JohnSmith (e.g. JohnSmith@company.com)

(b) JSmith (e.g. JSmith@company.com)

(c) John.Smith (e.g. John.Smith@company.com)

Note that options (a) and (c) are identical if punctuation characters are ignored. In this case, there are only two options, (a) and (b).

A given T-alterative for PersonalName may potentially be represented in the form, <FirstName> <Middlelnitial><LastName>, considered in the definition of feature C1. If the PersonalName cannot be represented in this form, the <Middlelnitial> is excluded from the comparison since it is rarely included in an email address. Even though the EU1 feature is computed for any T-alterative of both CompanyName and PersonalName fields, the resulting value has the opposite meaning for the two fields. Specifically, a high EU1 value significantly increases the confidence of PersonalName and reduces the confidence of CompanyName. Therefore, the EU1 weights in the final decision making rule (FIG. 3) have different signs for the two fields.

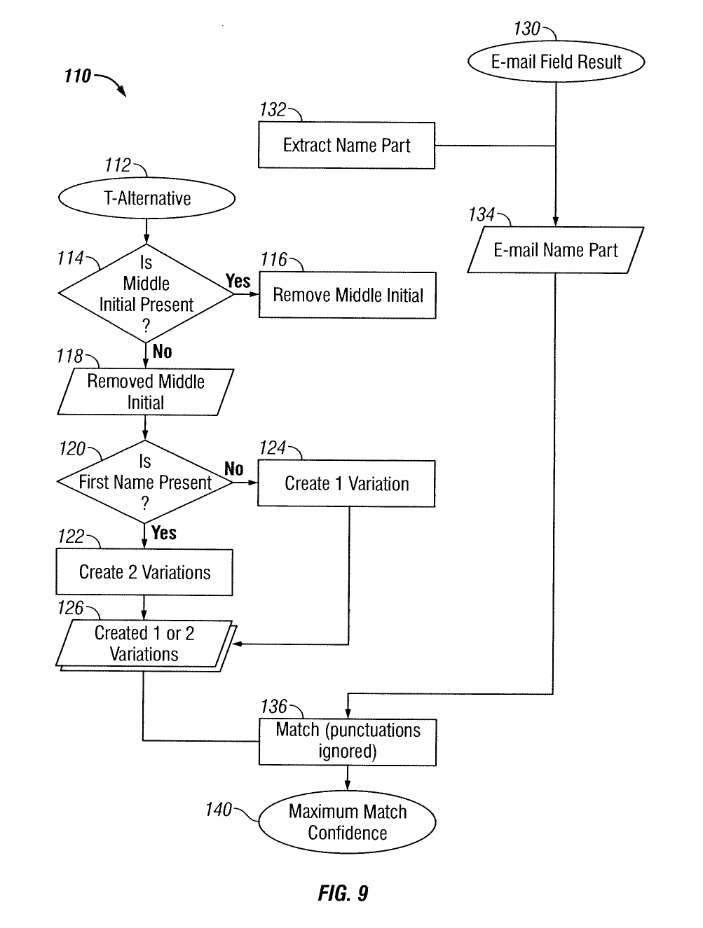

FIG. 9 is a flowchart 110 for a method for determining the confidence of a match against the name part of an email address. Specifically, step 112 involves inputting a PersonalName T-alternative (e.g., “John S. Smith”). Step 114 involves determining whether a middle initial is present in the PersonalName T-alternative, while step 116 involves removing the <MiddleName> component if it is present. Step 118 represents the name after the possible removal of the <MiddleName> component (e.g., “John Smith”). Step 120 involves determining whether the first name is present. If the first name is present, step 122 involves creating variations (a) and (b) of the first name, as set forth above. If the first name is not present, step 124 involves leaving the first name as a single variation. Step 126 represents the one or two variations of the first name. In the present example, there are two variations including “John Smith” and “J Smith.”

With further reference to FIG. 9, step 130 involves inputting the email field result (e.g., jsmith@company.com). Step 132 involves extracting the name part from the email address, whereas step 134 represents the email's name part (e.g., “jsmith”). Step 136 involves matching each variation of step 136 against the email's name part of step 134. Since punctuation characters and letter case are ignored, the following confidence values are determined:

For variation “John Smith”: MatchConf=6/9 (“ohn” are three letters from total nine unmatched).

For variation “J Smith”: MatchConf=6/6=1.0 (all six letters are matched).

In step 140, the maximum confidence from step 136 is output (its EU1 value). In the illustrated example, the confidence is 1.0.

Feature EU2 is a match against the “company” part of the email and URL addresses. This feature is based on the fact that the Company name is often included in the “company” part of the email and URL fields. Given a T-alternative Name and a set of “company” parts, Company[i] (i=1, . . . N), EU2 may be defined as follows:

EU2=max (MatchConf(Name, Company[i])), over all i=1, . . . N

Note that EU-alternatives are not subjected to the EU2 feature since they have been created as the “company” part of email and URL addresses. Additionally, even though the EU2 feature is computed for any T-alterative of both CompanyName and PersonalName fields, the resulting value has the opposite meaning for the two fields. Particularly, a high EU2 value significantly increases the confidence of CompanyName and reduces the confidence of PersonalName. Therefore, the EU2 weights in the final decision making rule have different signs (FIG. 3).

Capturing Job Titles

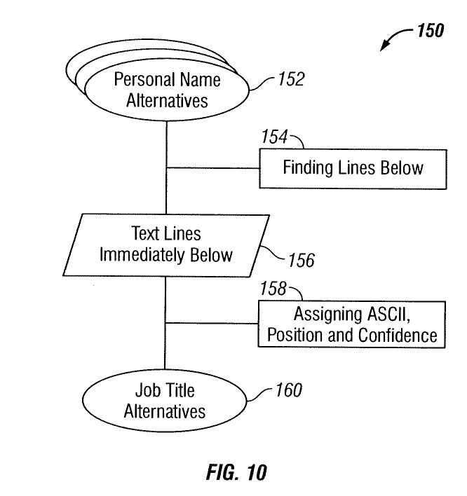

Job titles can be found using locations of found personal names. Specifically, job titles are usually located immediately below the names. Referring to FIG. 10, a flowchart 150 for a method for capturing Job Titles will now be described. In step 152, all found Personal Name alternatives are provided. Step 154 involves detecting text lines below the PersonalName alternatives using Page Segmentation (FIG. 2). Step 156 represents the locations found in step 154. Step 159 involves assigning positions, ASCII and confidence values to the locations. Confidence is identical to that of the respective Personal Name alternative. In step 160, all found Job Title alternatives are sorted from higher to lower confidence values.

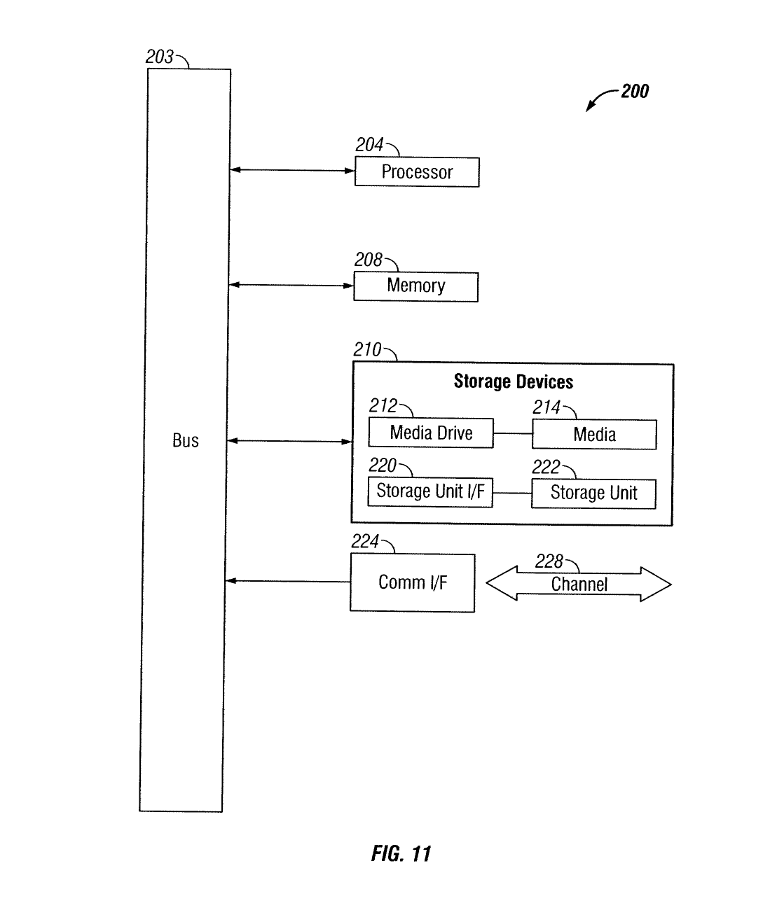

As used herein, the term module might describe a given unit of functionality that can be performed in accordance with one or more embodiments of the present invention. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 11. Various embodiments are described in terms of this example-computing module 200. After reading this description, it will become apparent to a person skilled in the relevant art how to implement the invention using other computing modules or architectures.

Referring now to FIG. 11, computing module 200 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 200 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 200 might include, for example, one or more processors, controllers, control modules, or other processing devices, such as a processor 204. Processor 204 might be implemented using a general-purpose or special-purpose processing engine such as, for example, a microprocessor, controller, or other control logic. In the illustrated example, processor 204 is connected to a bus 202, although any communication medium can be used to facilitate interaction with other components of computing module 200 or to communicate externally.

Computing module 200 might also include one or more memory modules, simply referred to herein as main memory 208. For example, preferably random access memory (RAM) or other dynamic memory, might be used for storing information and instructions to be executed by processor 204. Main memory 208 might also be used for storing temporary variables or other intermediate information during execution of instructions to be executed by processor 204. Computing module 200 might likewise include a read only memory (“ROM”) or other static storage device coupled to bus 202 for storing static information and instructions for processor 204.

The computing module 200 might also include one or more various forms of information storage mechanism 210, which might include, for example, a media drive 212 and a storage unit interface 220. The media drive 212 might include a drive or other mechanism to support fixed or removable storage media 214. For example, a hard disk drive, a floppy disk drive, a magnetic tape drive, an optical disk drive, a CD or DVD drive (R or RW), or other removable or fixed media drive might be provided. Accordingly, storage media 214 might include, for example, a hard disk, a floppy disk, magnetic tape, cartridge, optical disk, a CD or DVD, or other fixed or removable medium that is read by, written to or accessed by media drive 212. As these examples illustrate, the storage media 214 can include a computer usable storage medium having stored therein computer software or data.

In alternative embodiments, information storage mechanism 210 might include other similar instrumentalities for allowing computer programs or other instructions or data to be loaded into computing module 200. Such instrumentalities might include, for example, a fixed or removable storage unit 222 and an interface 220. Examples of such storage units 222 and interfaces 220 can include a program cartridge and cartridge interface, a removable memory (for example, a flash memory or other removable memory module) and memory slot, a PCMCIA slot and card, and other fixed or removable storage units 222 and interfaces 220 that allow software and data to be transferred from the storage unit 222 to computing module 200.

Computing module 200 might also include a communications interface 224. Communications interface 224 might be used to allow software and data to be transferred between computing module 200 and external devices. Examples of communications interface 224 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 224 might typically be carried on signals, which can be electronic, electromagnetic (which includes optical) or other signals capable of being exchanged by a given communications interface 224. These signals might be provided to communications interface 224 via a channel 228. This channel 228 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 208, storage unit 220, media 214, and channel 228. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 200 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for capturing data from a business card containing multiple fields, comprising:
generating a list of T-alternatives for each field;
computing an ASCII value for each T-alternative; and
computing a confidence for each T-alternative.

2. The method of claim 1, wherein the list of T-alternatives is ordered from highest to lowest confidence.

3. The method of claim 1, wherein the step of generating a list of T-alternatives for each field comprises determining a list of T-alternatives for a PersonalName field and a list of T-alternatives for a CompanyName field.

4. The method of claim 3, wherein the confidence for each T-alternative is computed as a weighted average.

5. The method of claim 4, wherein computing the confidence for a T-alternative comprises the steps of:
inputting a T-alternative;
computing one or more features of the T-alternative;
computing a value for each feature;
inputting an array of weights, one per feature; and computing a weighted average for the T-alternative.

6. The method of claim 5, wherein the weighted average is computed using the formula:
V=Σ(F[i]*W[i])/ΣW[i], where
F[i] is the value of the i-th feature,
W[i] is the weight of the i-th feature, and
Σ is the summation over all features.

7. The method of claim 5, wherein the computed features comprise text segmentation features, location features, content features, font features, and features for matching against email and URL fields.

8. A method for capturing an email, URL or telephone number from an image of a business card having multiple fields, comprising:
selecting a particular field;
inputting a set of keywords for the field;
inputting OCR results of the image including ASCII and location information;
inputting a format of the field;
determining any alternative keyword locations within the OCR results along with corresponding match confidences;
determining any alternative data locations within the OCR results along with corresponding match confidences; and
combining the keyword locations and data locations such that the keywords are properly aligned with the data, with no other text items in between.

9. The method of claim 8, further comprising sorting all found field alternatives from higher to lower confidences.

10. The method of claim 8, wherein the step of inputting a format of the field is performed using a regular expression mechanism, wherein the various format-related factors are converted into rules that are used to identify alternative locations within the input text that may be data positions or keyword positions.

11. A method for determining a confidence of a match against a name part of an email address captured from a business card, the method comprising:
inputting a T-alternative of the name part of the email address;
determining whether a middle initial is present in the T-alternative and removing the middle initial if present;
determining whether a first name is present and creating a second T-alternative of the first name if present;
inputting the email address and extracting the name part from the email address; and
matching each T-alternative against the name part from the email address and determining a match confidence for each T-alternative.

12. The method of claim 11, further comprising selecting the T-alternative having the highest match confidence.

13. The method of claim 12, further comprising determining a job title corresponding to the T-alternative having the highest match confidence.

14. The method of claim 13, wherein determining the job title comprises detecting text below the T-alternative using page segmentation.

15. The method of claim 14, wherein determining the job title further comprises assigning positions, ASCII and confidences to all text locations.

16. The method of claim 15, wherein determining the job title further comprises selecting the job title having the highest confidence.
